(19) United States
(12) Patent Application Publication
(10) Pub. No.: US 2016/0369995 A1
(43) Pub. Date: Dec. 22, 2016

(54) OPTICAL SEMICONDUCTOR LIGHTING APPARATUS

(71) Applicant: Posco LED Company Ltd., Yongin-si (KR)

(72) Inventors: Yoon Gil Jang, Yongin-si (KR); Hyun Ku Park, Yongin-si (KR); Kyung Rye Kim, Yongin-si (KR); Su Woon Lee, Yongin-si (KR); Sang Hyuk Kim, Yongin-si (KR); Seok Jin Kang, Yongin-si (KR)

(21) Appl. No.: 14/740,791

(22) Filed: Jun. 16, 2015

(51) Int. Cl. F21V 29/76; F21V 29/75; F21V 15/01; F21V 29/67

(52) U.S. Cl. CPC F21V 29/767; F21V 29/673; F21V 29/75; F21V 15/01; F21Y 2101/02

(57) ABSTRACT

An optical semiconductor lighting apparatus according to exemplary embodiments of the present invention provides a heat radiation member having a heat radiation plate where heat radiation fins are disposed radially, a cooling member disposed in an internal space at the center part of the heat radiation plate which inner curved portions of the heat radiation fins form, a light emitting member coupled to a lower surface of the heat radiation plate, and a cover coupled to the outer edge of the heat radiation member while covering the cooling member wherein the heat radiation fins comprise a first heat radiation fin and a second heat radiation fin which is lower than the first heat radiation fin.

### BACKGROUND

Field

Exemplary embodiments relate to an optical semiconductor lighting apparatus. More particularly, exemplary embodiments relate to an optical semiconductor lighting apparatus which enhances heat dissipation ability by upgrading an air flow mechanism and maintains the heat dissipation ability regardless of the position of the apparatus while reducing weight of the apparatus. Further, exemplary embodiments relate to an optical semiconductor lighting apparatus which prevents breakdown of the apparatus which may be caused by harmful materials such as workplace dust and makes the assembly process easy and fast.

Discussion of the Background

Instead of incandescent or fluorescent lamps, lighting apparatuses using an optical semiconductor are becoming widely used in households or offices, as well as industrial workplaces, because they have many advantages such as high luminous efficiency and low power consumption. Further, they do not use toxic substances such as mercury, which may be used in the fluorescent lamps, thereby being more environmental friendly. Therefore, the demand of the lighting apparatus using an optical semiconductor is increasing rapidly, and many companies are now using optical semiconductor lighting apparatuses in their factories. A light emitting diode LED is a typical element using an optical semiconductor.

However, optical semiconductor lighting apparatuses in factories are often exposed to severe conditions such as high temperature. Further, optical semiconductor lighting apparatuses the comprise LEDs radiate heat. Therefore, to reduce the heat and protect the optical semiconductor lighting apparatuses from the severe conditions, effective cooling mechanisms are necessary.

Heat sources such as LEDs are disposed inside of the optical semiconductor lighting apparatuses, so additional elements for cooling the apparatuses are necessarily installed therein. Consequently, the lighting apparatuses with the cooling mechanisms tend to be large in size and weigh too much. To solve this problem, it is important to design and select an appropriate number and forms of the elements in the optical semiconductor lighting apparatuses, which make it possible to assemble the lighting apparatuses easily and faster, and reduce the size of them while securing its capabilities.

Additionally, when used in factories, harmful materials like dust or foreign substances may exist which may enter into the lighting apparatuses to cause them to breakdown. The harmful materials may also stick to reflectors in the apparatuses and reduce the luminous efficiency and heat dissipation efficiency. In order to prevent accumulation of the harmful materials, workers have to disassemble and clean the lighting apparatuses frequently, and this may increase the cost of maintenance. Therefore, it is necessary to prevent those harmful materials from sticking thereto while cooling them simultaneously.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an optical semiconductor lighting apparatus which is lightweight, easy to assemble, and prevents harmful materials from sticking thereto while effectively cooling itself.

Additional aspects will be set forth in the detailed description which follows, and, in part, will be apparent from the disclosure, or may be learned by practice of the inventive concept.

According to exemplary embodiments, an optical semiconductor lighting apparatus may comprise a body comprising a light emitting member, the light emitting member further comprising optical semiconductor devices, a heat radiation member disposed above the light emitting member, and a cooling member coupled to an upper side of the heat radiation member and a cove coupled to an outer peripheral edge of the heat radiation member while covering the cooling member, wherein the heat radiation member comprises a heat radiation plate with heat radiation fins disposed radially and inner curved portions of the heat radiation fins form an internal space at a center part of the heat radiation plate configured to accommodate at least part of the cooling member.

According to exemplary embodiments, the heat radiation fins may comprise a first heat radiation fin and a second heat radiation fin which has a height lower than a height of the first heat radiation fin.

According to exemplary embodiments, the first heat radiation fin and the second heat radiation fin may be disposed alternately.

According to exemplary embodiments, one end of at least one of the heat radiation fins may be disposed at the outer peripheral edge of the heat radiation plate.

According to exemplary embodiments, each of the heat radiation fins may have a top portion and an outer curved portion which is configured to be longer and curved more gradually than the inner curved portion.

According to exemplary embodiments, the cooling member may be supported by top portions of the heat radiation fins.

According to exemplary embodiments, a curved surface of the cover may be configured to contact with an outer curved portion of the heat radiation fins.

According to exemplary embodiments, the cooling member may comprise a bracket coupled to the upper side of the heat radiation member, and a fan coupled to a lower surface of the bracket and disposed in the internal space.

According to exemplary embodiments, the cooling member may comprise a bracket having an edge piece forming an outer peripheral structure, and a center piece connected to the edge piece and having a fan disposed thereunder.

According to exemplary embodiments, the bracket may further comprise at least one or more inner pieces connecting the center piece and the edge piece.

According to exemplary embodiments, the cooling member may comprise a bracket having a guide groove configured to enable an electric power line to be disposed therein.

According to exemplary embodiments, the cooling member may comprise a bracket forming at least one opening.

According to exemplary embodiments, the cooling member may comprise a fan and a ring which surrounds an upper part of the fan.

According to exemplary embodiments, an optical semiconductor lighting apparatus may comprise a heat radiation member comprising a heat radiation plate with radially disposed heat radiation fins, a cooling member disposed in an internal space at a center part of the heat radiation plate which inner curved portions of the heat radiation fins form, a light emitting member coupled to a lower surface of the heat radiation plate and having optical semiconductor devices; and a cover coupled to an outer edge of the heat radiation member and configured to cover the cooling member, wherein the heat radiation fins comprise a first heat radiation fin and a second heat radiation fin which has a height lower than a height of the first heat radiation fin.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view of an optical semiconductor lighting apparatus according to an exemplary embodiment.

FIG. 2 is perspective views of elements of the optical semiconductor lighting apparatus according to an exemplary embodiment.

FIG. 3 is a perspective view of a heat radiation member and a light emitting member of the optical semiconductor lighting apparatus according to an exemplary embodiment.

FIG. 4 is a top view of the part in FIG. 3.

FIG. 5 is a bottom view of the part in FIG. 3.

FIG. 6 is a cross sectional view of the part taken from a sectional line I-I′ in FIG. 4.

FIG. 7 is a perspective view of a body of the optical semiconductor lighting apparatus according to an exemplary embodiment.

FIG. 8 is a perspective view of a cooling member of the optical semiconductor lighting apparatus according to an exemplary embodiment.

FIG. 9 is a front view of the cooling member in FIG. 8.

FIG. 10 is a top view of the body in FIG. 7.

FIG. 11 is a perspective view of the optical semiconductor lighting embodiment with a supporting member according to an exemplary embodiment.

FIG. 12 is a cross sectional view showing the characteristics of the optical semiconductor lighting apparatus according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

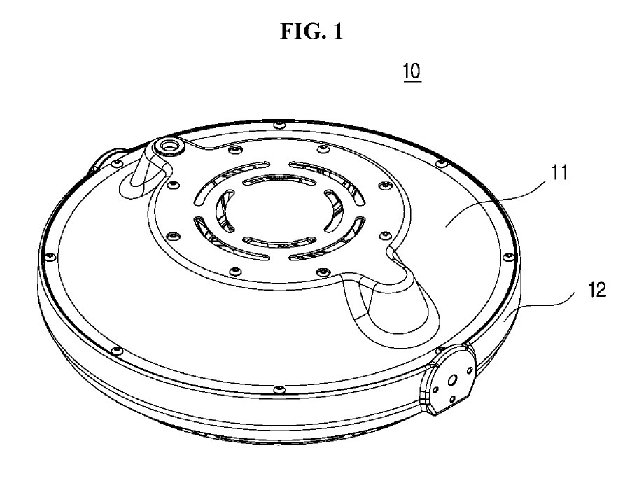

FIG. 1 shows a perspective view of the optical semiconductor lighting apparatus 10 according to the exemplary embodiment. Referring to FIG. 1, the optical semiconductor lighting apparatus 10 may have a cover 11 and a body 12. The body 12 may have light emitting devices such as LEDs mounted on a printed circuit board PCB, a heat radiation element such as heat radiation fins, and a cooling element. The body itself may function as an optical semiconductor lighting apparatus without the cover 11.

The optical semiconductor lighting apparatus 10 shown in FIG. 1 may have a circular form but it is not limited thereto, therefore, an appropriate shape may be selected from various shapes, such as a quadrangle, a polygon, etc., depending on the installation conditions and to enhance the radiation effect maximally.

Regarding the whole shape of the optical semiconductor lighting apparatus 10 shown in FIG. 1, the apparatus 10 may be designed to have a lower height compared to the conventional apparatus with the help of the structures of the body 12 and this may contribute to a reduction of costs and prevention of excessive consumption of materials for manufacturing the apparatus 10. The structures of the body 12 will be described in detail as below.

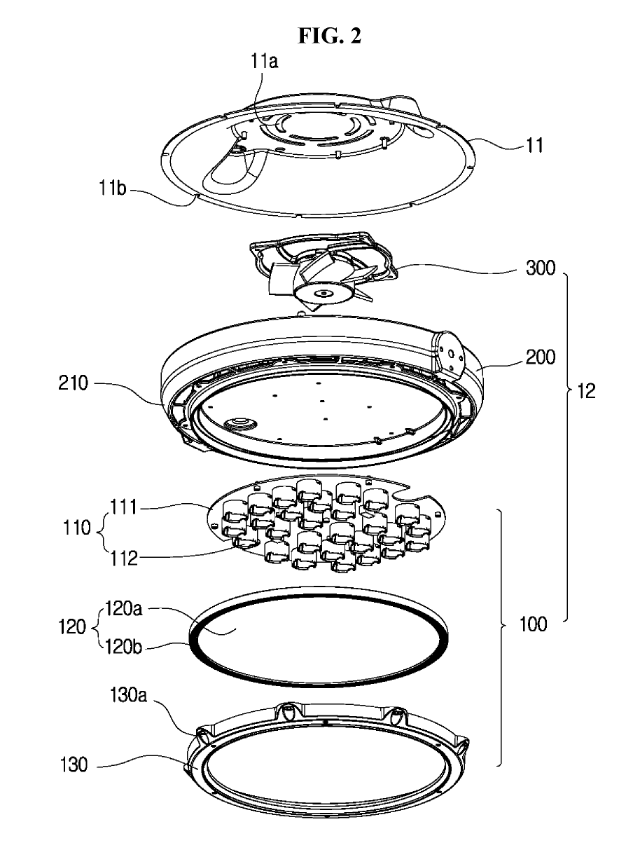

FIG. 2 shows perspective views of elements of the optical semiconductor lighting apparatus 10 according to the exemplary embodiment. Referring to FIG. 2, the optical semiconductor lighting apparatus 10 may have the cover 11 and the body 12 as described above, and more particularly, the body 12 may have a light emitting member 100, a heat radiation member 200, and a cooling member 300.

The light emitting member 100 may comprise a light emitting module 110, which may have a plurality of optical semiconductor devices 112 mounted on a printed circuit board PCB 111, a transparent window 120, and a fixing unit 130.

The PCB 111 may have the optical semiconductor devices 112 on its lower surface and the upper surface of the PCB 111 may be coupled to a lower surface of the heat radiation member 200. The heat generated from the optical semiconductor devices 112 is conducted to the heat radiation member 200 through the PCB 111. The PCB 111 may be a metal core PCB or metal PCB based on a metal board having good thermal conductivity. The optical semiconductor devices 112 are primary heat sources in the optical semiconductor lighting apparatus 10.

Each of the optical semiconductor devices 112 may have an LED element and an optical lens which surrounds the LED element. The optical lens may be formed as having a plurality of unit lenses which correspond to the number of the LEDs. The optical lens adjusts an angle of light emitted from the optical semiconductor devices 112 to prevent the diffusion of the light.

The transparent window 120 may comprise a transparent board 120a and a packing 120b which surrounds the edge of the transparent board 120a. The transparent window 120 may cover the light emitting module 110 and also fix the module 110 stably by pressing it with the fixing unit 130. The fixing unit 130 presses the edge of the transparent window 120 and may be coupled to the edge of the lower surface of the heat radiation member 200. The fixing unit 130 may be formed as a ring, but it is not limited thereto. The transparent window 120 prevents the diffusion of the light emitted from the optical semiconductor devices 112.

Along the edge of the transparent window 120, a plurality of holes 130a may be formed at a periphery of the fixing unit 130 and, by using bolts, the fixing unit 130 may be coupled to the outer peripheral edge of the lower side of the heat radiation member 200 while stably pressing the transparent window 120 and the light emitting module 110 to the lower side of the heat radiation member 200.

However, regardless of the fixing unit 130, the PCB 111 of the light emitting module 110 may be coupled directly to a lower surface of the heat radiation member 200 by surface-to-surface contact and this may help the heat from the optical semiconductor devices 112 efficiently transfer to the heat radiation member 200.

Referring to FIG. 2, the heat radiation member 200 may have a heat radiation plate 210 and the plate 210 may have the light emitting member 100 thereunder and absorb the heat generated from the optical semiconductor devices 112 of the light emitting member 100. The heat radiation member 200 absorbs the heat from the optical semiconductor devices 112 of the light emitting module 110 and radiates the heat to the atmosphere by thermal radiation with the help of its structural characteristics. More detail regarding the structural characteristics of the heat radiation member 200 will be described as below.

In an exemplary embodiment, the heat radiation member 200 may have the cooling member 300 on an upper surface of the heat radiation plate 210 thereof. The cooling member 300 sends fresh air down to the heat radiation member 200 to cool it down. The cooling member 300 may be preferably disposed over the heat radiation member considering that the heated air is bound to rise because of its low density. However it is not limited thereto.

Referring to FIG. 2, the cover 11 may be disposed on the body 12 and coupled to an upper side of the heat radiation member 200 to cover and protect the cooling member 300 and the upper side of the heat radiation member from being contaminated by harmful materials in workplaces such as factories, where the optical semiconductor lighting apparatus according to the exemplary embodiment may be employed.

The cover may have an air inlet 11a on the upper surface thereof, and the air inlet 11a allows the fresh air to enter into the optical semiconductor lighting apparatus 10 according to the exemplary embodiment. The form and number of the air inlets 11a may be properly designed and selected depending on how much fresh air is necessary to cool the apparatus 10 effectively. The position of the air inlet 11a may be directly over the position of the cooling member 300 to provide the fresh air directly to the cooling member 300, but exemplary embodiments not limited thereto.

Similarly to the fixing unit 130, a plurality of grooves at periphery 11b may be formed along the edge of the cover 11 and, by using bolts, the cover 11 may be coupled to the outer peripheral edge of the upper side of the heat radiation member 200 while covering the cooling member 300. The coupling means, such as bolts, may vary and exemplary embodiments are not limited thereto.

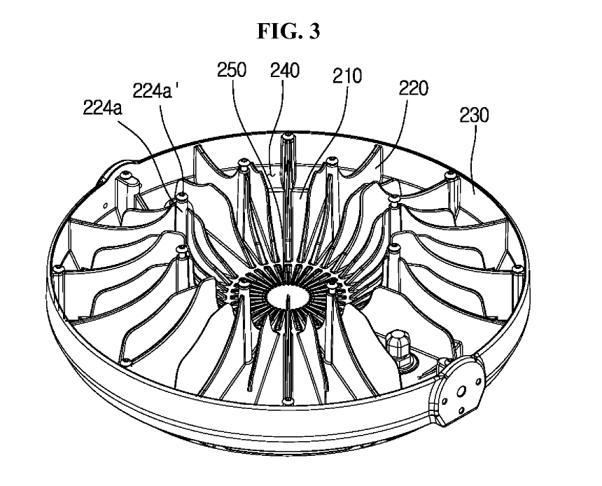

FIG. 3 shows a perspective view of the heat radiation member 200 as a part of the body 12 of the optical semiconductor lighting apparatus 10 according to an exemplary embodiment. Referring to FIG. 3, the heat radiation member 200 may comprise a heat radiation plate 210, a plurality of heat radiation fins 220, and a side wall 230. Further, air guide fins 250 may be formed on the heat radiation plate 210, and air outlets 240 may be formed between the edge of the heat radiation plate 210 and the side wall 230.

The heat radiation plate 210 may be made of metallic materials having high heat conductivity (i.e., thermally conductive) which may be improved if the heat radiation plate 210 becomes thinner and wider. Considering these characteristics, the size of the heat radiation plate 210 may be designed to be optimized depending on an amount of the heat required to be transferred from the PCB 111 and the installation condition of the optical semiconductor lighting apparatus 10.

The shape of the heat radiation plate 210 may be a circular shape but it is not limited thereto. Any appropriate shape may be selected from various shapes, such as quadrangle, a polygon, etc., depending on the installation condition and to enhance the radiation effect maximally.

The heat radiation plate 210 may be exposed directly to the atmosphere so that it can radiate the heat transferred from the PCB 111 immediately. Simultaneously, the plate 210 is also able to transfer the heat from the PCB 111 to the heat radiation fins 220 connected on it. As a result, the heat radiation plate 210 is able to carry out the heat radiation effectively.

Referring to FIG. 3, the heat radiation fins 220 may be disposed radially on the upper surface of the heat radiation plate 210, having gaps along the outer peripheral edge of the plate 210. The heat radiation fins 220 radiate the heat transferred from the heat radiation plate 210 and provide the gap between two fins 220 adjacent to each other which may function as way for the heat to be transported and lead to air outlets 240. One of ordinary skill in the art may be able to select an appropriate number and length of the fins 220 based upon the heat radiation temperature, temperature of the environment, costs, etc. Any of the heat radiation fins 220 may connect the heat radiation plate 210 and a side wall 230.

An inner surface of the side wall 230 may be connected to one end of any of the heat radiation fins 220, and the outer surface of the side wall 230 may be exposed to the atmosphere directly. Therefore, the side wall 230 may function to dissipate the heat transferred from the heat radiation plate 210 and the heat radiation fins 220 by its outer surface contacting the air, as well as function as a housing so as to protect and enclose the apparatus.

The side wall 230 may also be made of metallic materials having a high thermal conductivity, and the heat radiation plate 210 and the heat radiation fins 220 may be made of the same materials as the side wall 230 to provide the effect of heat transfer.

Referring to FIG. 3, air guide fins 250 may be formed in the center part of the heat radiation plate 210. It may be understood that “the center part” of the heat radiation plate 210 means a regular area of the upper surface of the plate 210 around the center point of the circular shape of the plate 210. The center part of the heat radiation plate 210 may directly face the lower side of the cooling member 300 and receive the fresh air coming down from the cooling member 300.

The air guide fins 250 may be formed radially in a manner similar to the heat radiation fins 220, and be disposed on the heat radiation plate 210 corresponding to the position of the cooling member 300 positioned thereover. They may guide the fresh air from the cooling member 300 to each of the gaps of the heat radiation fins 220, therefore it may make the fresh air cool the heat radiation member 200 effectively. The position and number of the air guide fins 250 may vary depending on the position and number of the cooling member 300.

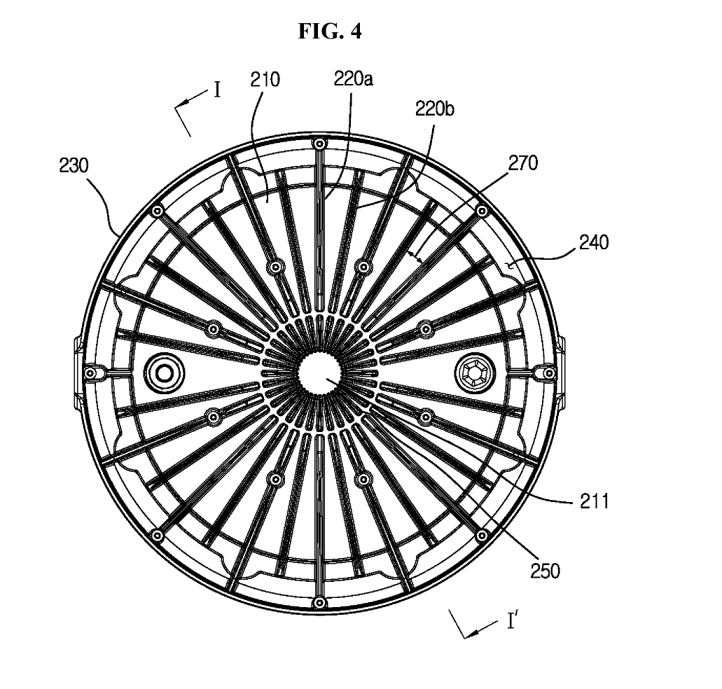

FIG. 4 shows a top view of the heat radiation member 200 of the optical semiconductor lighting apparatus 10 according to the exemplary embodiment. Referring to FIG. 4, the air guide fins 250 may be disposed radially on the center part 211 of the heat radiation plate 210 and each of the air guide fins 250 may correspond to each of the heat radiation fins 220.

The heat radiation fins 220 may comprise first heat radiation fins 220a and second heat radiation fins 220b. The first heat radiation fins 220a are formed to be longer than the second heat radiation fins 220b and one end of each of the first heat radiation fins 220a is connected to the inner side of the side wall 230 so that the first heat radiation fins 220a connect the heat radiation plate 210 and the side wall 230 and the heat generated from the optical semiconductor devices 112 transfers from the heat radiation plate 210 to the side wall 230 through the first heat radiation fins 220a. In an exemplary embodiment, one end of each of the second heat radiation fins 220b may be disposed at the outer peripheral edge of the heat radiation plate 210, but exemplary embodiments are not limited thereto. The first and second heat radiation fins 220a and 220b may be disposed alternately.

By increasing the number of the heat radiation fins 220, the area of heat radiation surface may be widen, however, cooling effectiveness may decrease when the gap 270 between two fins 220 becomes narrower so that it makes the heated air difficult to be released. Therefore, one of skill in the art will be able to select appropriate number of the first and second heat radiation fins 220a and 220b considering an amount of heat transfer, temperature of workplace, etc.

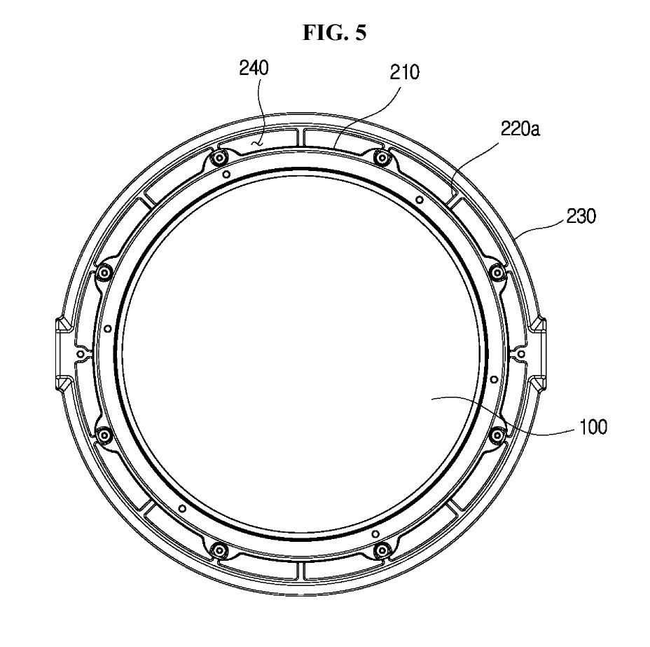

FIG. 5 shows the bottom view of the body 12 of the optical semiconductor lighting apparatus 10 according to the exemplary embodiment. Referring to FIGS. 4 and 5, the outer peripheral edge of the heat radiation plate 210 may surround the light emitting member 100 and the air outlet 240 may be formed between the outer peripheral edge of the heat radiation plate 210 and the side wall 230. The number of the air outlet 240 may be determined according to the number of the first heat radiation fins 220a. In an exemplary embodiment, the heat radiation plate 210 may have the air outlet 240 at the outer peripheral edge thereof without the side wall 230 regardless of the fins 220.

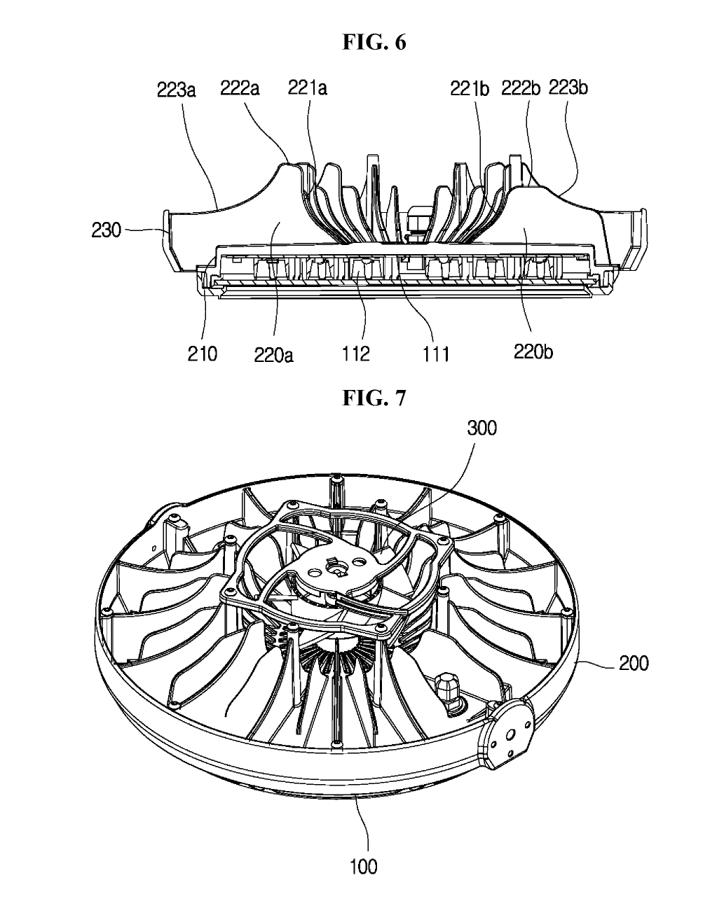

FIG. 6 shows a cross sectional views taken from the sectional line I-I′ of FIG. 4. Outer ends of the first and second heat radiation fins 220a and 220b may surround the outer peripheral edge of the heat radiation plate 210. As mentioned above, the first heat radiation fin 220a may be configured to be longer than the second heat radiation fins 220b and be connected to the inner surface of the side wall 230.

The first heat radiation fin 220a may have an inner curved portion 221a, a top portion 222a, and an outer curved portion 223a. The inner curved portions 221a of the first heat radiation fins 220a are disposed surrounding the center part of the heat radiation plate 210 and form an internal space which may accommodate at least part of the cooling member 300. The internal space may be a bowl shape that provides enough space for the cooling member 300 to be disposed. This may reduce the height of the optical semiconductor lighting apparatus 10 by accommodating the cooling member in that space, and a required space for setting up the lighting apparatus 10 on a basic structure such as a ceiling may be minimized.

The outer curved portion 223a may be formed longer and be curved more gradually than the inner curved portion 221a, and extend to the side wall 230. Any of the top portions 222a may be used for supporting the cooling member. Further, a supporting piece 224a may be configured to protrude at the top portion 222a and the cooling member 300 may be mounted on the top portions 222a and fixed stably by bolts through holes 224a′ (FIG. 3) formed on top of the supporting piece 224a, but embodiments are not limited thereto and any other coupling method may be used.

The second heat radiation fin 220b may also have an inner curved portion 221b, a top portion 222b, and an outer curved portion 223b. Each of the portions 221b, 222b, and 223b has a similar form with that of the portions 221a, 222a, and 223a. However, the height of the top portion 222b may be lower than that of the top portion 222a, therefore, an upper part between two top portions 222a adjacent to each other may be wider than the gap 270 (FIG. 4). This may provide wider heat paths at the upper part and help the heated air flow out more easily.

Further, swirling of the heated air at the end of the heat radiation fins 220 may be prevented since the fins 220b, being shorter than the fins 220a, do not disturb the air venting between two fins 220a at the outer edge of the plate 210 (FIG. 4). Consequently, the optical semiconductor lighting apparatus 10 according to an exemplary embodiment may provide enough heat radiation fins forming the gaps 270 (FIG. 3) for heat transfer, and also enhance the air venting by configuring two kinds of fins which have different heights and lengths (FIGS. 4 and 6).

FIG. 7 shows a perspective view of the body 12 of the optical semiconductor lighting apparatus 10 according to an exemplary embodiment. As described above, the body 12 may have the light emitting member 100, the heat radiation member 200, and the cooling member 300. The light emitting member 100, as a heat source, may be disposed under the heat radiation member 200 while transferring the heat to the heat radiation member 200. The cooling member disposed over the heat radiation member 200 may send fresh air to the heat radiation member 200.

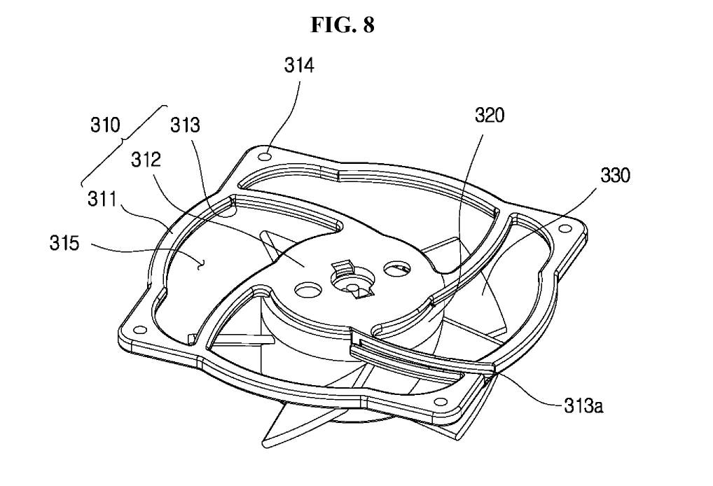

FIG. 8 shows a perspective view of the cooling member 300 of the optical semiconductor lighting apparatus 10 according to an exemplary embodiment of. The cooling member 300 may comprise a bracket 310, a ring 320, and a fan 330. The fan 330 may be coupled to the lower surface of the bracket 310.

The bracket 310 of the cooling member 300 may consist of an edge piece 311, the center piece 312 and inner pieces 313. The edge piece 311 of the bracket 310 may form an outer peripheral structure and the center piece 312 may be connected to the edge piece 311 through each of the inner pieces 313. Further, any of the inner pieces 313 may have a guide groove 313a which enables an electric power line to be disposed therein.

The bracket 310 may also have openings 315 surrounded by those pieces, and these openings 315 may help the fresh air enter into the fan 330 more easily. With this structure, the weight of the cooling member 300 may decrease down to approximately 90% of conventional devices, and this contributes to lightening of the optical semiconductor lighting apparatus 10.

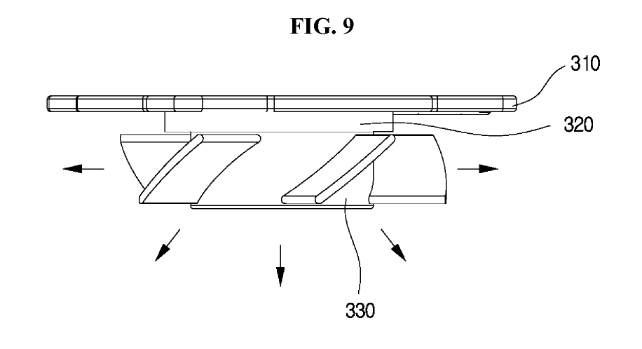

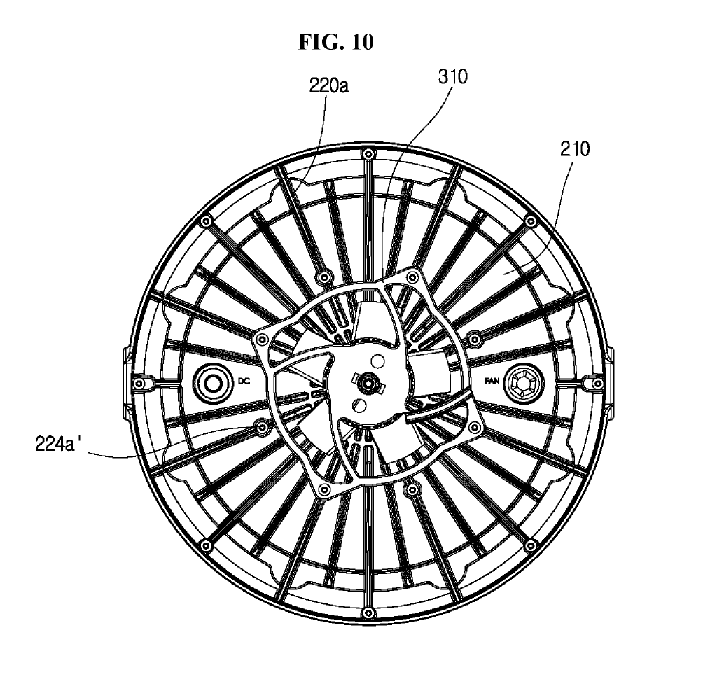

FIG. 9 shows a front view of the cooling member 300 of FIG. 8. The bracket 310 may be formed as a thin plate and this structure may enhance the efficiency of the fan 330 since the bracket 310 does not surround the side of the fan 330 so that the fan 330 can sends the fresh air radially without any obstacle. Furthermore, this structure may prevent harmful materials such as dust from sticking to the cooling member 300 since it has openings 315 and no housing surrounding the fan 330. On the other hand, the ring 320 may surround an upper part of the fan 330 to protect the fan 330 from being contaminated by the harmful materials such as dust in workplace. The ring 320 may be made of elastic materials such as a rubber, but it is not limited thereto.

FIG. 10 shows a top view of the body 12 in FIG. 7. The cooling member 300 may be disposed over the center part 211 (FIG. 4) of the heat radiation plate 210. Aligning the edge hole 314 of the bracket 310 with the hole 224a′, the bracket 310 may be coupled to the supporting piece 224a (FIG. 3) of the first heat radiation fin 220a by bolts or other fasteners.

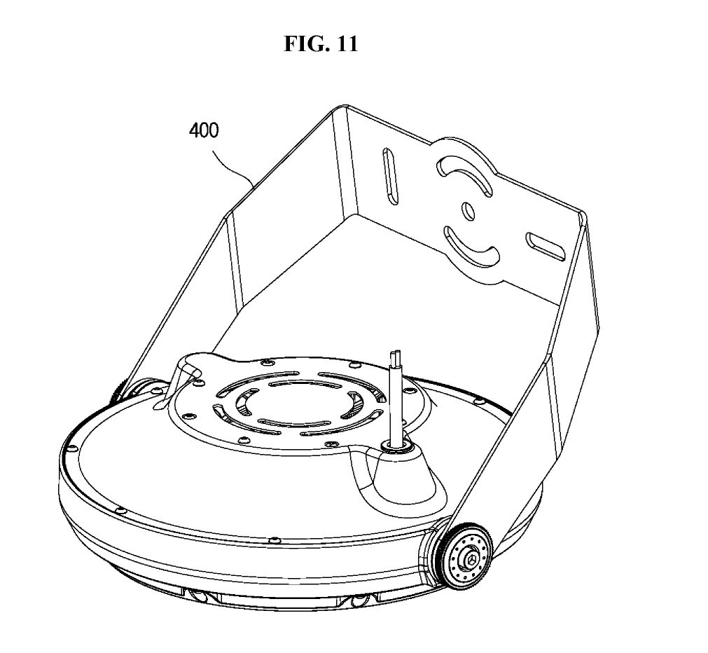

FIG. 11 shows the optical semiconductor lighting apparatus 10 with a supporting member 400 according to the exemplary embodiment of the present invention. The optical semiconductor lighting apparatus 10 may be operable regardless of the position of the apparatus 10 with the help of its compact shape. Therefore, the apparatus 10 may be installed on the ground or other surface supported by the supporting member 400 as shown in FIG. 11, which is not limited thereto, and also be installed at a ceiling, facing downward.

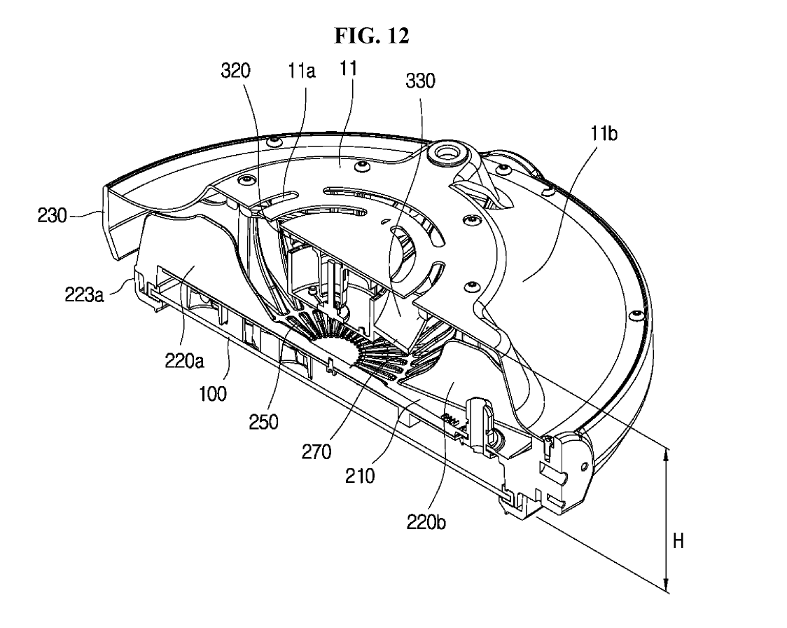

FIG. 12 shows a cross sectional view illustrating the characteristics of the optical semiconductor lighting apparatus according to an exemplary embodiment.

Referring to FIG. 12, the heat generated from the light emitting member 100 transfers to the heat radiation plate 210. A part of the heat may radiate directly from the plate 210, and another part of the heat transfers to the heat radiation fins 220 and also radiate. Some of the heat may transfer to the side wall 230 through the fins 220 and radiate directly to the atmosphere.

When the fan 330 starts to work, the air outside of the optical semiconductor lighting apparatus 10 starts to enter into the apparatus 10 through the air inlet 11a. As described above, the air can pass through the fan 330 more easily since the bracket 310 of the cooling member 300 has openings 315 corresponding to the air inlet 11a (FIG. 8).

The air through the fan 330 may go down to the center part of the heat radiation plate 210 while cooling the plate 210 and also move to the gap 270 between two fins 220 following the air guide fins 250 while cooling the fins 220. Finally, the air hits the inner side of the side wall 230 while cooling it and then goes out through the air outlet 240 while preventing the harmful materials such as dust from covering the light emitting member 100 (FIG. 4).

In an exemplary embodiment, the air may also move directly to the fins 220 since the fan 330 is not surrounded by any obstacle such as a housing of the fan. Further, the height of the second heat radiation fins 220b is lower than that of the first heat radiation fins 220a so that the air moved directly to the fins 220 can pass easily through an upper space between two first heat radiation fins 220a adjacent to each other, which is wider than the gap 270. Furthermore, the curved surface at periphery 11b of the cover 11 may be formed to contact with the outer curved portion 223a so that it can form the air passage between two fins 220 completely. In this manner, the air effectively cools the heat radiation member 200.

Referring FIG. 12, the ring 320 prevents the harmful materials such as dust, which may come with the air outside, from entering into the fan 330 so that it can secure the life span of the fan 330 and reduce maintenance. As mentioned above, it is possible to reduce the height H of the apparatus 10 since the fan 330 may be disposed in the internal space of the center part of the heat radiation plate 210.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An optical semiconductor lighting apparatus comprising:
a body comprising a light emitting member, the light emitting member further comprising optical semiconductor devices, a heat radiation member disposed above the light emitting member, and a cooling member coupled to an upper side of the heat radiation member; and
a cover coupled to an outer peripheral edge of the heat radiation member while covering the cooling member;
wherein the heat radiation member comprises a heat radiation plate with heat radiation fins disposed radially, and
inner curved portions of the heat radiation fins form an internal space at a center part of the heat radiation plate configured to accommodate at least part of the cooling member.

2. The optical semiconductor lighting apparatus of claim 1, wherein the heat radiation fins comprise a first heat radiation fin and a second heat radiation fin which has a height lower than a height of the first heat radiation fin.

3. The optical semiconductor lighting apparatus of claim 2, wherein the first heat radiation fin and the second heat radiation fin are disposed alternately.

4. The optical semiconductor lighting apparatus of claim 1, wherein one end of at least one of the heat radiation fins is disposed at the outer peripheral edge of the heat radiation plate.

5. The optical semiconductor lighting apparatus of claim 1, wherein each of the heat radiation fins has a top portion and an outer curved portion which is configured to be longer and curved more gradually than the inner curved portion.

6. The optical semiconductor lighting apparatus of claim 1, wherein the cooling member is supported by top portions of the heat radiation fins.

7. The optical semiconductor lighting apparatus of claim 1, wherein a curved surface of the cover is configured to contact with outer curved portions of the heat radiation fins.

8. The optical semiconductor lighting apparatus of claim 1, wherein the cooling member comprises:
a bracket coupled to the upper side of the heat radiation member; and
a fan coupled to a lower surface of the bracket and disposed in the internal space.

9. The optical semiconductor lighting apparatus of claim 1, wherein the cooling member comprises a bracket having:
an edge piece forming an outer peripheral structure; and
a center piece connected to the edge piece and having a fan disposed thereunder.

10. The optical semiconductor lighting apparatus of claim 9, wherein the bracket further comprises at least one or more inner pieces connecting the center piece and the edge piece.

11. The optical semiconductor lighting apparatus of claim 1, wherein the cooling member comprises a bracket having a guide groove configured to enable an electric power line to be disposed therein.

12. The optical semiconductor lighting apparatus of claim 1, wherein the cooling member comprises a bracket forming at least one opening.

13. The optical semiconductor lighting apparatus of claim 1, wherein the cooling member comprises a fan and a ring which surrounds an upper part of the fan.

14. An optical semiconductor lighting apparatus comprising:
a heat radiation member comprising a heat radiation plate with radially disposed heat radiation fins;
a cooling member disposed in an internal space at a center part of the heat radiation plate which is surrounded by inner curved portions of the heat radiation fins;
a light emitting member coupled to a lower surface of the heat radiation plate, the light emitting member further comprising optical semiconductor devices; and
a cover coupled to an outer edge of the heat radiation member and configured to cover the cooling member,
wherein the heat radiation fins comprise a first heat radiation fin and a second heat radiation fin which has a height lower than a height of the first heat radiation fin.

15. The optical semiconductor lighting apparatus of claim 14, wherein each of the first and the second radiation fins further has a top portion and an outer curved portion which is configured to be longer and curved more gradually than the inner curved portion, and
the cooling member is configured to be supported by the top portions of the fins.

16. The optical semiconductor lighting apparatus of claim 15, wherein a curved surface of the cover is configured to contact with the outer curved portion.

17. The optical semiconductor lighting apparatus of claim 14, wherein the first heat radiation fin and the second heat radiation fin are disposed alternately.

18. The optical semiconductor lighting apparatus of claim 14, wherein one end of the second heat radiation fin is disposed at an outer peripheral edge of the heat radiation plate.

19. The optical semiconductor lighting apparatus of claim 14, wherein the cooling member comprises:
a bracket coupled to the upper side of the heat radiation member; and
a fan coupled to a lower surface of the bracket and disposed in the internal space.

20. The optical semiconductor lighting apparatus of claim 14, wherein the cooling member comprises a bracket having:
an edge piece forming an outer peripheral structure; and
a center piece connected to the edge piece and comprising a fan disposed thereunder.

21. The optical semiconductor lighting apparatus of claim 20, wherein the bracket further comprises at least one or more inner pieces connecting the center piece and the edge piece.

22. The optical semiconductor lighting apparatus of claim 14, wherein the cooling member comprises a bracket having a guide groove configured to enable an electric power line to be disposed therein.

23. The optical semiconductor lighting apparatus of claim 14, wherein the cooling member comprises a bracket forming at least one opening.

24. The optical semiconductor lighting apparatus of claim 14, wherein the cooling member comprises a fan and a ring which surrounds an upper part of the fan.
